(19) United States
(12) Patent Application Publication
(10) Pub. No.: US 2015/0323260 A1
(43) Pub. Date: Nov. 12, 2015

(54) Spiral Heat Exchanger and Corresponding Manufacturing Method

(71) Applicant: Faurecia Systemes D'Echappement, Nanterre (FR)

(72) Inventor: Frederic Greber, Ecot (FR)

(21) Appl. No.: 14/703,937

(22) Filed: May 5, 2015

(30) Foreign Application Priority Data
May 7, 2014 (FR) 14 54146

(51) Int. Cl. F28D 9/00; B23P 15/26

(52) U.S. Cl. CPC F28D 9/0018; B23P 15/26

(57) ABSTRACT

The heat exchanger comprises a lower metal sheet, —an upper metal sheet, and a fin sheet delimiting the fins. The lower metal sheet, the upper metal sheet and the fin sheet form a three-layer structure wound in a spiral, whereby the lower metal sheet and the upper metal sheet delimit a first passage for the circulation of a first fluid. The heat exchanger has a set of spacers arranged in the first passage, whereby these spacers are rods separate from the lower and upper metal sheets.

### RELATED APPLICATION

This application claims priority to FR 14 54146, filed May 7, 2014.

### TECHNICAL FIELD

The invention relates in general to heat exchangers.

### BACKGROUND

More specifically, the invention relates in a first aspect to a heat exchanger comprising: a lower metal sheet; an upper metal sheet; and a fin sheet delimiting the fins. The lower metal sheet, the upper metal sheet, and the fin sheet are superposed to form a three-layer structure spirally wound around a central axis and delimiting a winding. The first large faces with respect to the lower metal sheet and the upper metal sheet delimit a first passage between them for the circulation of a first fluid. The second large faces with respect to the lower metal sheet and the upper metal sheet delimit a second passage between them for the circulation of a second fluid in which the fin sheet is arranged.

A heat exchanger of this type is known from WO 2005/017435. The lower and upper metal sheets of the heat exchanger are stamped out in such a way as to constitute the inlet and outlet for the fluids, and to maintain constant space between the two plates.

The manufacture of a heat exchanger of this type is complex.

In this context, the invention aims to provide a heat exchanger offering simpler manufacture.

### SUMMARY

To this end, the invention relates to a heat exchanger of the aforementioned type, wherein the heat exchanger has a set of spacers arranged in the first passage, whereby these spacers are rods that are separate from the lower and upper metal sheets.

Thus, in the manufacture of the heat exchanger, it is possible to use flat plates that are not stamped out. The spacers ensure the spacing between the lower metal sheet and the upper metal sheet, and thus control a free section of the first passage.

The heat exchanger may also have one or more of the features below, taken individually or in all technically possible combinations:
the set of spacers has a peripheral spacer interposed between respective peripheral edges of the lower and upper metal sheets to provide a seal between the said peripheral edges;
the peripheral spacer comprises two longitudinal rods extending along long edges of the lower and upper metal sheets;
the peripheral spacer is a frame having a closed contour;
the first passage has outer and inner circumferential ends respectively oriented radially outwards and radially inwards in the heat exchanger, whereby the set of spacers has at least one central spacer extending circumferentially over the largest portion of the length of the first passage and dividing the first passage into an outgoing branch and a returning branch, which are parallel to one another and communicate with one another at the inner circumferential end, preferably only at the inner end;
the heat exchanger has a first fluid inlet communicating with the outgoing branch at the outer circumferential end, and a first fluid outlet communicating with the returning branch at the outer circumferential end;
the exchanger has a cylindrical external casing into which the winding is inserted;
the upper and lower metal sheets form a specified number of turns around the central axis, with the fin sheet forming one extra turn than the upper and lower metal sheets, whereby the said extra turn is interposed between the upper metal sheet and the external casing;
the heat exchanger comprises an internal tube around which the structure with three layers is wound, whereby the internal tube is a wound metal sheet with superposition of two axial edges of the said wound metal sheet and/or the external casing is a wound metal sheet with superposition of the two axial edges of the said wound metal sheet; and
the fin sheet delimiting the fins is a folded metal sheet with corrugations, whereby the said corrugations constitute the fins;
the fins are corrugations that are parallel to the central axis;
the fins are blades that extend parallel to the central axis; and
the fins extend across the entire lateral width of the lower and upper metal sheets.

According to a second aspect, the invention relates to a method of manufacturing a heat exchanger having the following steps: formation of the three-layer structure by superposing the lower metal sheet, the upper metal sheet and the sheet, with the interposition of the set of spacers in the first passage between the lower and upper metal sheets; winding of the three-layer structure spirally around the central axis.

The method may also include one or more of the following steps, taken individually or in all technically possible combinations:
a step to pressurize the first passage in order to press the upper metal sheet against the sheet, whereby this is carried out after the winding step;
a step to fix a first fluid inlet tube and a first fluid outlet tube on the upper metal sheet, whereby this is carried out before the forming step and the winding step; and
a step to insert the structure into a cylindrical casing.

According to yet another aspect, the invention relates to an exhaust line comprising a heat exchanger having the above features, whereby the second circulation passage is fluidly connected to a duct for circulation of the exhaust gas, while the first passage is interposed in a heat recovery circuit in which a coolant circulates.

### BRIEF DESCRIPTION OF THE DRAWINGS

Other characteristics and advantages of the invention will become apparent from the detailed description which is given below, but which is for information only and is not limitative, and with reference to the accompanying figures, in which:

FIG. 1 shows an exploded perspective view of some of the heat exchanger elements of the invention before winding;

FIG. 2 shows a side view of the plates and the sheet delimiting the fins after winding;

FIG. 3 shows a side view of the complete exchanger;

FIG. 4 shows a schematic plan view of the heat exchanger of FIG. 3;

FIG. 5 shows a diagram of the steps of the inventive manufacturing process;

FIG. 6 shows an enlarged view of a part of FIG. 2 showing the deformation of the plates after pressurizing the first passage; and

FIG. 7 shows a simplified schematic representation of an exhaust line representing the heat exchanger of the invention.

### DETAILED DESCRIPTION

The heat evaporator shown in the figures is typically designed to be installed in a vehicle exhaust line. The vehicle is, for example, a motor vehicle, typically a car or truck.

This heat exchanger is, for example, an evaporator for a Rankine-type circuit. The exhaust gases circulate from a first side of the evaporator. A coolant circulates from a second side of the heat exchanger, whereby the exhaust gases transfer part of their heat energy to the coolant flowing through the evaporator. The coolant may be of any type: water, an ethanol/water mixture, or an R134 or R245fa type refrigerant or any other type of organic fluid compatible with a Rankine circuit. This fluid enters the heat exchanger in the form of a liquid and is evaporated by being brought into thermal contact with the exhaust gases.

Alternatively, the heat exchanger is not an evaporator but a simple heat exchanger between two fluids. Each of these fluids may be in gas or liquid form.

The heat exchanger may be used not only in an exhaust line, but in any other part of a motor vehicle, or even in any kind of industrial plant.

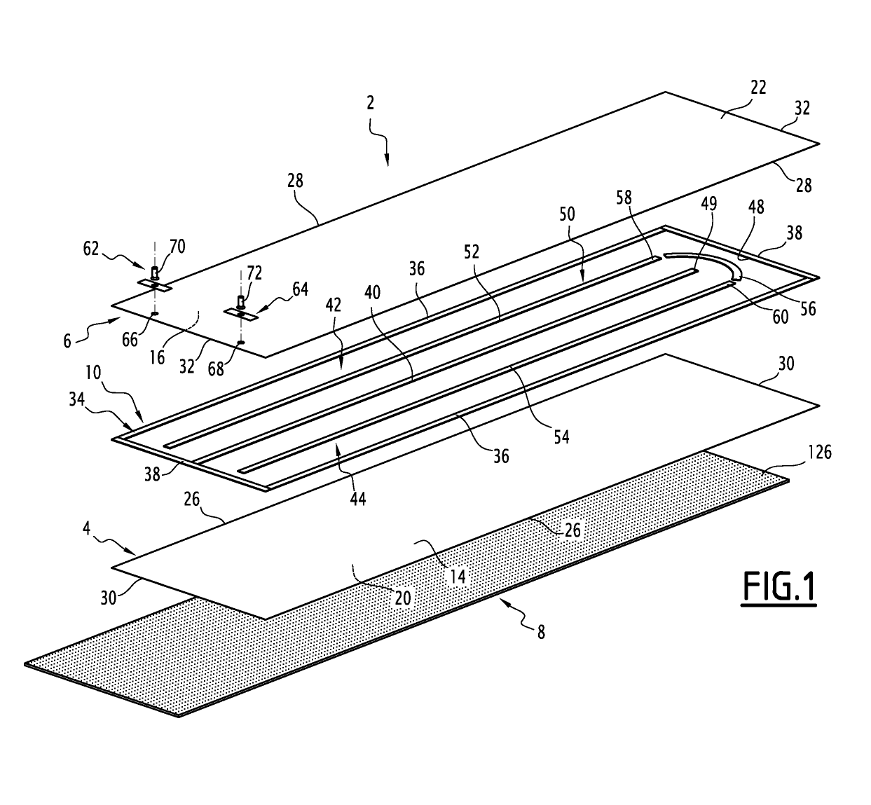

As shown in FIG. 1, the heat exchanger 2 comprises: a lower metal sheet 4; an upper metal sheet 6; a fin sheet 8 delimiting the fins; and a set of spacers 10 interposed between the lower metal sheet 4 and the upper metal sheet 6.

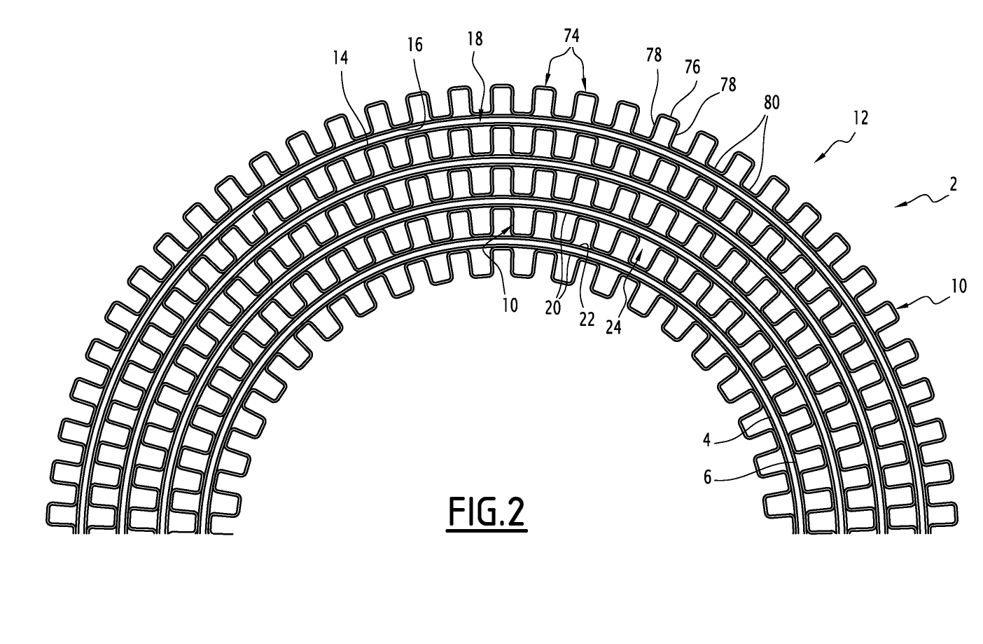

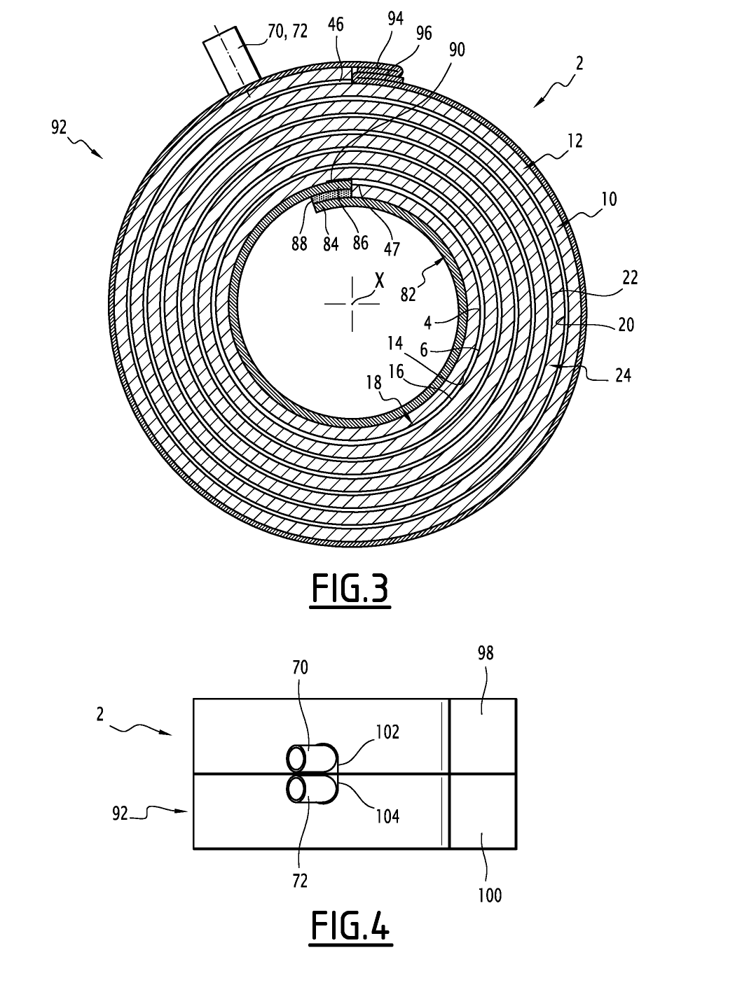

As can be seen, in particular in FIGS. 2 and 3, the lower metal sheet 4, the upper metal sheet 6 and the fin sheet 8 are superposed to form a three-layer structure spirally wound around a central axis X, thus forming a winding 12.

The respective first large faces 14, 16 of the lower metal sheet 4 and of the upper metal sheet 6 delimit between them a first passage 18 for the circulation of a first fluid.

The respective second large faces 20, 22 of the lower metal sheet 4 and of the upper metal sheet 6 delimit between them a second passage 24 for the circulation of a second fluid in which the fin sheet 8 is arranged.

The first and second large faces 14, 20 of the lower metal sheet 4 are opposite one another. The first and second large faces 16, 22 of the upper metal sheet 6 are opposite one another.

The lower metal sheet is, for example, made of stainless steel such as 316L. Alternatively, it may be made of 1.4301 (austenitic steel) or 444 (terrific steel).

It has a thickness between 0.1 and 0.4 mm, preferably between 0.15 and 0.3 mm, more preferably equal, for example, to 0.2 mm.

The upper metal sheet 6 is typically made of the same material and has the same thickness as the lower metal sheet 4.

In the example shown, the lower metal sheet 4 and the upper metal sheet 6 each have a rectangular shape in their developed state. Each of them is delimited by two long sides, respectively 26, 28, and two short sides, respectively 30, 32.

Alternatively, the lower and upper metal sheets 4, 6 do not have a rectangular shape, but may have any other suitable shape.

The three-layer structure is wound so that the short sides 30, 32 are parallel to the central axis X, while the long sides 26, 28 are wound circumferentially about the axis X.

As can be seen in the figures, the spacers 10 are arranged in the first passage 18 in order to maintain a predetermined spacing between the first large faces 14, 16 of the lower 4 and upper 6 metal sheets. These spacers 10 are independent of the upper and lower metal sheets 4, 6. By this is meant that the spacers 10 are separate from the upper and lower metal sheets 4, 6. They are not integral with the lower and upper metal sheets 4, 6. They are not made of protuberances provided in the lower and upper metal sheets 4, 6, for example by stamping out these sheets. The spacers are arranged between the lower and upper metal sheets 4, 6.

As can be seen in FIG. 1, the spacers 10 are rods. Specifically, the spacers 10 are metal rods with a flattened cross-section. By rod is meant here an elongated profile, preferably with a full cross-section. This cross-section is of small dimensions compared to the length of the profile. This cross-section is preferably rectangular, but may also be slightly oval or have any other suitable shape.

For example, each spacer 10 has a substantially rectangular cross-section with a width between 1 and 20 mm, preferably between 5 and 15 mm, and equal, for example, to 10 mm. Each spacer 10 has a cross-section with a thickness between 0.1 and 1 mm, preferably between 0.3 and 0.7 mm and more preferably equal to about 0.5 mm. The spacers 10 are typically made of the same material as the lower and upper metal sheets 4, 6. Alternatively, they may be of a different material.

The use of the rods as spacers ensures the width of the first passage 18, without significantly increasing the heat transfer coefficient of the first fluid to the lower and upper metal sheets 4 and 6. The rods do not interfere with the winding of the three-layer structure since they have a reduced cross-section and therefore a moderate rigidity.

The set of spacers 10 has a peripheral spacer 34 interposed between the respective peripheral edges of the lower and upper metal sheets 4, 6 to provide a seal between the said peripheral edges.

For example, the lower metal sheet 4 and the upper metal sheet 6 are seal-welded to the peripheral spacer 34.

In the example shown, the peripheral spacer 34 comprises two longitudinal rods 36 extending along the long edges 26, 28 of the lower and upper metal sheets, and two lateral rods 38 extending along the short edges 30, 32 of the lower and upper metal sheets.

The peripheral spacer 34 constitutes a frame having a closed contour, delimiting an empty central space. In the example shown, the rods 36, 38 are rigidly secured to one another, for example by welding.

Within the winding, the rods 38 are parallel to the X axis, while the rods 36 are wound circumferentially about the axis X.

The set of spacers 10 further comprises at least a central spacer 40 extending circumferentially over the largest portion of the length of the first passage 18, and dividing the first passage 18 into at least an outgoing branch 42 and a returning branch 44, which are parallel to one another.

More specifically, the first passage 18 has outer and inner circumferential ends 46, 47 respectively located radially further outside and radially further inside the heat exchanger (see FIG. 3). At the outer circumferential end, the central spacer 40 extends as far as the peripheral spacer 34 and thus isolates the outgoing branch 42 and the returning branch 44 from one another. This is shown in particular in FIG. 1, which shows a developed view of the spacers. However, in the case of the inner circumferential end of the first passage, the central spacer 40 does not extend as far as the peripheral spacer 34. Thus, the outgoing branch 42 and returning branch 44 communicate through an opening 48 at the inner circumferential end 47. In the example shown, the opening 48 is delimited between an end 49 of the central spacer 40 and the peripheral spacer.

Thus, U-shaped circulation is arranged for the first fluid in the first passage 18.

Preferably, the cross-section of the passage offered to the first fluid in the outgoing branch 42 is equal to the cross-section of the passage in the returning branch 44 and is equal to the cross-section of the passage at the opening 48.

According to an alternative embodiment not shown, the set of spacers 10 has two central spacers parallel to one another and placed head to tail. A first central spacer is arranged as shown in FIG. 1, in order to extend to the peripheral spacer at the outer circumferential end 46. This leaves an opening at the inner circumferential end 47 of the first passage. Another central spacer extends to the peripheral spacer 34 at the inner circumferential end 47 of the first passage, but has an opening at the outer circumferential end 46. One thus creates a circulation baffle for the first fluid within the first passage.

As shown in FIG. 1, the set of spacers 10 further has at least one intermediate spacer 50. The intermediate spacers 50 are preferably evenly distributed in the space internally delimited by the peripheral spacer 34. They are used to ensure the spacing between the lower metal sheet 4 and the upper metal sheet 6 in the areas of these plates that are not located near the central spacer or the peripheral spacer. They also help to make the heat exchanger more rigid.

In the example shown, the set of spacers 10 comprises a single U-shaped intermediate spacer 50. The spacer 50 has a first rod 52 extending to the centre of the outgoing branch 42 over the largest portion of the circumferential length of the branch 42. It further comprises a second rod 54, extending substantially along the largest portion of the circumferential length of the returning branch 44 and in the middle of the returning branch 44. The intermediate spacer 50 also has an arched rod 56 which crosses the opening 48. The arched rod 56 extends from a circumferentially inner end 58 of the first rod 52 to the circumferentially inner end 60 of the second rod 54. Small spaces separate the rods 52, 54 and the arched rod 56

The intermediate spacer 50 does not contribute to obtaining U or S shaped circulation as it does not extend to the peripheral spacer 34.

Furthermore, as shown in particular in FIG. 1, the heat exchanger includes a first fluid inlet 62 communicating with the outgoing branch 42 at the outer circumferential end 46 of the first passage, and a first fluid outlet 64 communicating with the returning branch 44 at the outer circumferential end 46.

To do this, the upper metal sheet 6 has inlet and outlet ports 66, 68 leading respectively into the branches 42 and 44. The heat exchanger 2 further comprises inlet and outlet tubes 70, 72 seal-welded on the upper metal sheet 6 and placed to coincide with the ports 66 and 68. The ports 66 and 68 are located near one of the edges 32 of the upper metal sheet.

The fin sheet 8 is typically a metal sheet folded in such a way as to delimit a plurality of corrugations 74 forming the fins that are parallel to one another.

As shown in FIG. 1, the fin sheet 8 has substantially the same width, measured along the X axis, as the lower and upper metal sheets 4 and 6. The corrugations 74 all extend in parallel to the X axis.

As shown in FIG. 2, each corrugation 74 has a substantially U-shaped cross-section perpendicular to the X axis. Each corrugation 74 thus has a flat top 76 extended by two sidewalls 78. Two adjacent corrugations 74 are connected to one another by a substantially flat base 80. The base 80 connects the sidewalls 78 to one another with respect to the two adjacent corrugations. The top 76 and the base 80 have a substantially circumferential orientation, while the sidewalls 78 have a substantially radial orientation relative to the X axis.

The fins are thus blades extending parallel to the central axis X. Here, the term blade means a thin part with a much thinner width than its length.

Before winding, the fin sheet 8 is placed under the lower metal sheet 4 so that the tops 76 of the corrugations are pressed against the lower metal sheet 4. Thus, after winding, the bases 80 of the sheet are pressed against the upper metal sheet 6. Specifically, for each winding of the three-layer structure, the tops 76 of the corrugations are pressed against the lower metal sheet 4 of the winding, while the bases 80 are pressed against the upper metal sheet 6 of the previous winding, i.e. the winding immediately radially inside.

As can be seen in FIG. 3, fin sheet 8 has a circumferential length greater than that of the lower and upper metal sheets 4 and 6. It makes an additional winding.

Fin sheet 8 is typically made of stainless steel of the 316L austenitic type. Alternatively, it may be made of aluminium or 1.4301 (austenitic steel) or 444 (ferritic steel). It is made from a sheet 0.2 mm thick. The slots have, for example, a height between 2.5 and 10 mm, equal, for example, to 3.7 mm. The slots are circumferentially arranged with a regular pitch, for example a pitch of between 1.5 and 5 mm, and typically equal to 3.2 mm.

As can be seen in FIG. 3, the heat exchanger 2 comprises an internal tube 82 around which the winding of the three-layer structure is carried out. The internal tube 82 is substantially coaxial to the axis X.

In an exemplary embodiment, the internal tube 82 is a wound metal plate with a slight overlap of the two edges 84, 86 of the said sheet. The edges 84 and 86 delimit the sheet parallel to the X axis and are rigidly attached to one another. Advantageously, a spacer or shim 88 is interposed radially between the edges 84 and 86. One thus creates along the edge 86 a step with a height substantially corresponding to the combined thickness of the fin sheet 8, the plates 4, 6 and the set of spacers 10.

The upper metal sheet 6 has an excess length 90 which extends circumferentially slightly beyond fin sheet 8, for example by about 10 mm. This excess length 90 is rigidly fixed to the central tube 82, and more specifically to the edge 86. The fin sheet 8, the lower metal sheet 4 and the spacer 34 abut against the edge 86 and against the shim 88.

At the first winding of the three-layer structure, i.e. the radially innermost winding, the bases 80 are pressed against the internal tube 82.

The central tube 82 has a mean diameter of, for example, 40 mm.

As can also be seen in FIG. 3, the heat exchanger 2 comprises a cylindrical external casing 92 in which is contained the winding 12.

The external casing 92 is coaxial to the axis X. In the embodiment shown in FIG. 3, this casing is made of a sheet wound about the axis X. It thus has two edges parallel to the X axis 94, 96, which overlap and which are rigidly attached to one another. In the example shown, the edge 94 is folded towards the inside of the exchanger. The edge 96 is bent towards the outside. The edge 94 is located above the edge 96, i.e. radially outwards with respect to the edge 96. A step is thus formed along the edge 96, whose height corresponds to three times the thickness of the plate. This step has a height substantially corresponding to the combined thickness of the fin sheet 8, the lower and upper metal sheets 4 and 6 and the spacers.

It should be noted that, along the last winding of fin sheet 8, i.e. of the radially outermost turn of the winding, the flat tops 76 are pressed against the inner surface of the casing 92.

The arrangement shown in FIG. 3 offers the advantage that it is possible to wind the three-layer structure spirally, with a substantially uniform pressure at every point of the winding. In the absence of movement at the internal tube and the external casing, the two circumferential ends of the three-layer structure experience a higher compression and deformation. This deformation could result in the occurrence of hot spots during the use of the heat exchanger. The deformation could permanently damage the plates thus creating leaks.

As can be seen in FIG. 4, the external casing 92 preferably has two cylindrical parts 98, 100. The parts 98, 100 are in contact with one another via their respective edges, whereby the plane of contact is substantially perpendicular to the axis X. The cylindrical parts 98 and 100 are seal-welded to one another. Each of the two cylindrical parts 98, 100 is delimited with respect to the other cylindrical part by a circumferential edge in which is formed a recess, respectively 102, 104. The inlet and outlet tubes 70, 72 protrude from the external casing 92, respectively via the recess 102 and the recess 104. The space separating the tubes 70, 72 from the edges of the recesses 102, 104 is closed and sealed by any suitable means.

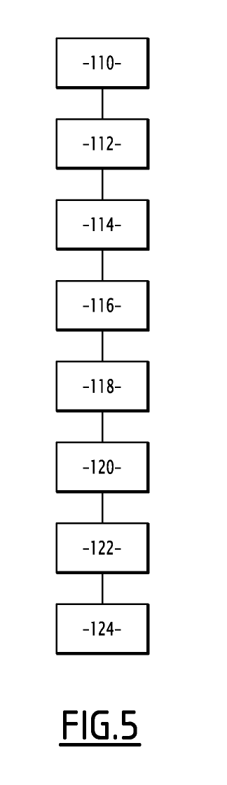

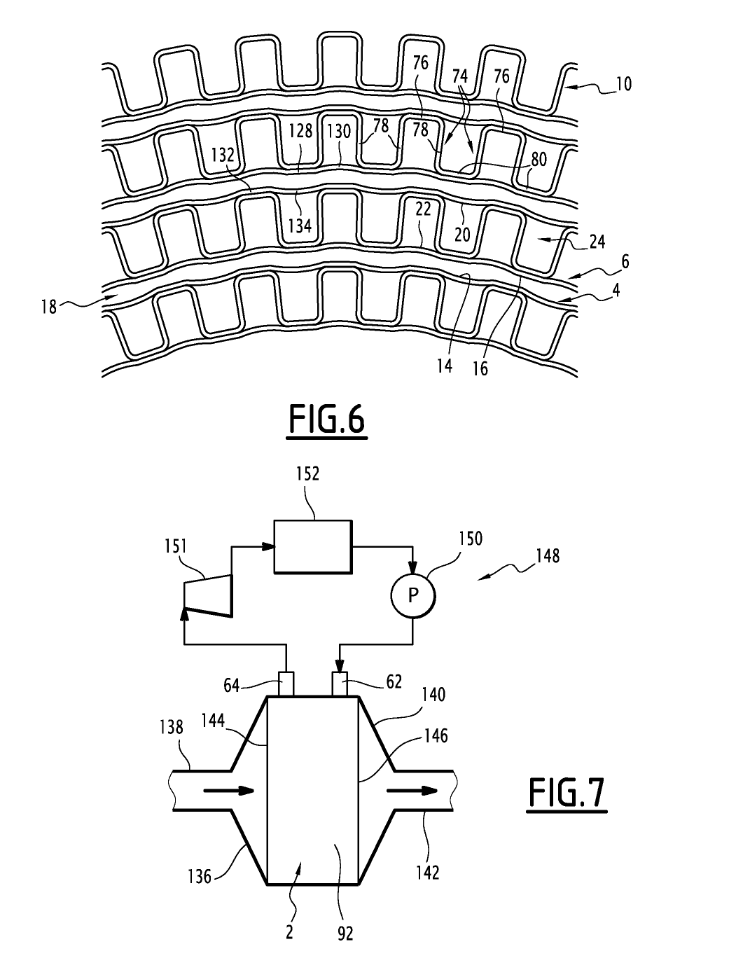

The heat exchanger manufacturing method will now be detailed with reference to FIGS. 5 and 6.

The method comprises at least the following steps: preferably weld the inlet and outlet tubes 70, 72 to the upper sheet 6 (step 110); superpose the lower metal sheet 4, the set of spacers 10 and the upper metal sheet 6 (step 112); preferably weld the lower metal sheet 4 and the upper metal sheet 6 to the spacers (step 114); superpose the fin sheet 8 on the lower and upper metal sheets 4 and 6 (step 116); wind the three-layer structure in a spiral around the central axis X (step 118); preferably place the coil in the cylindrical external casing 92 (step 120); pressurise the first passage to press the upper metal sheet against fin sheet 8 (step 122); preferably close the central tube (step 124).

Typically, the orifices 66 and 68 will have already been made in the upper metal sheet before the start of step 110.

At step 114, the lower and upper metal sheets 4 and 6 are each welded to all the spacers. Welding enables sealing to be made between the lower and upper metal sheets 4 and 6 and the peripheral spacer 34. The central spacer 40 is initially locked in position on plate 4 by spot welding. Then, once plate 6 is in position, plates 4 and 6 and the central spacer 40 are seal-welded together. The spacer 50 is welded in the same way, except that it is not necessary to weld it continuously over its entire length.

It is possible to obtain fin sheet 8 with the fins already formed. Alternatively, the method includes a step to form the fins, in particular the recesses 74, from a flat sheet.

During step 116, fin sheet 8 is pressed against the lower metal sheet 4, and is rigidly attached to it. More specifically, one end 126 of fin sheet 8 that is intended to be positioned radially innermost in the heat exchanger, is fixed by spot welding at several points on an end of the lower metal sheet 4 lying opposite the inlet and outlet 62, 64. The end 126 of fin sheet 8 is shifted slightly towards the inlet and outlet 62 and 64 in order to create the extra length 90, along which the lower metal sheet 4 is not covered by fin sheet 8.

Alternatively, fin sheet 8 is not rigidly fixed to plate 4.

To carry out the winding step 118, one first takes the internal tube 82 and fixes the extra length 90 to the internal tube 82. The three-layer structure is then wound circumferentially around the internal tube.

At step 120, the two cylindrical parts 98, 100 of the external casing are placed around the coil. They are put in place by sliding each part axially around the coil 12. The parts 98, 100 are oriented angularly about the X axis so that the tubes 70, 72 engage in the recesses 102, 104.

Alternatively, the external casing 92 is wound around the coil 12 and the edges 94, 96 are then welded to one another. In this case, the casing 92 is not made up of two parts 98, 100 but is a single unit.

During the winding step 118, a deformation of the lower and upper metal sheets 4 and 6 occurs.

The radial spacing between the second large faces 20, 22 is maintained during the winding because of the rigidity of fin sheet 8. The free section of the second passage 24 is thus preserved.

The lower metal sheet 4 is supported on fin sheet 8, especially by the corrugations 74, and therefore adopts a regular spiral shape. This is not true, however, for the upper metal sheet 6. Some areas of the upper metal sheet 6 are supported on the spacers and adopt a spiral shape. On the other hand, the areas of the upper metal sheet 6 that are not supported on a spacer will bear against the lower metal sheet 4. This is largely due to the fact that the sheets are thin.

Step 122 pressurizing the first passage allows the final positioning of the upper metal sheet 4 against the fins of the following winding. To do this, the first passage is maintained at a relatively high internal pressure of several tens of bars. For example, the pressure is about 35 bars for the 0.2 mm thick lower and upper metal sheets.

This pressure has the effect of distancing the upper metal sheet 6 from the lower metal sheet 4 and pressing the upper metal sheet 6 against the fins located immediately above. This also has the effect of pressing the lower metal sheet strongly against the fins of the same winding.

As can be seen in FIG. 6, some areas 128 of the upper metal sheet 6 then come into contact with the bases 80 interconnecting the corrugations 74.

Other areas 130 of the upper metal sheet 6 are located to the right of the corrugations 74, between the fins 78. The areas 130 adopt a concave shape that slightly penetrates into the internal volume of the corrugations 74.

A similar deformation is observed in the case of the lower metal sheet 4. Some areas 132 are pressed against the tops 76 of the corrugations during the pressurization. Other areas 134, located between two tops 76 adopt a concave shape, and slightly penetrate into the free space between two corrugations 74. In other words, there is deformation of the lower and upper metal sheets 4 and 6 so that the upper metal sheet contacts the base of the corrugations, while the lower metal sheet contacts the top of the corrugations.

These deformations enable one to block the fins in position and prevent any slippage of the fins relative to the lower and upper metal sheets.

At step 124, the central tube 82 is closed internally. This forces the second fluid to flow axially between the fins in the second passage.

The heat exchanger 2 is, for example, used in an exhaust line, as illustrated in FIG. 7. The second circulation passage is fluidly connected to a duct for circulation of the exhaust gas. The first passage is interposed in a heat recovery circuit in which a coolant circulates. The heat exchanger 2 operates as an evaporator.

A diverger 136 connects the external casing 92 to a duct 138 to carry the exhaust gas. This duct 138 is connected to a manifold (not shown), which captures the exhaust gas exiting the engine combustion chambers. A converger 140 connects the external casing 92 to an exhaust gas discharge duct 142. The duct 142 is connected to a cannula releasing exhaust gases into the atmosphere (not shown) with the interposition of one or more organs to purify the exhaust gases.

The heat exchanger 2 is delimited radially towards the outside by the external casing, and is axially delimited by two large faces 144, 146 that are substantially perpendicular to the X axis. The second passage 24 is open at both large faces 144, 146. The diverger 136 covers the surface 144 and distributes the exhaust gases coming from the duct 138 over the entire large face 144. Conversely, the converger 140 covers the large face 146 and captures the exhaust gas exiting the second passage 24.

The exhaust gases circulate axially through the heat exchanger in the various channels created by the fins. The exhaust gases yield a first part of their heat energy to the first fluid via the lower metal sheet and the upper metal sheet, and a second part to the fins delimited by fin sheet 8. The fins transfer the second part to the lower and upper metal sheets 4 and 6 by conduction.

The heat exchanger 2 is further connected to a heat recovery circuit 148. This circuit has a circulation unit, such as a pump 150, which causes the first fluid towards the inlet 62. It also has an expansion organ 151, for example a turbine, in which the steam exiting the heat exchanger 2 via the outlet 64 is expanded to low pressure. The circuit 148 further includes a condenser 152, interposed between the outlet of the expansion organ 151 and the suction of the pump 150.

The first fluid injected into the heat exchanger through inlet 62 runs through the outgoing branch 42 circumferentially from the outer circumferential end 46 to the inner circumferential end 47, passes through the opening 48, and then runs through the returning branch 44 in the opposite direction, circumferentially from the inner circumferential end 47 to the outer circumferential end 46. It leaves the heat exchanger through the outlet 64.

Due to the presence of the fins in the second passage 24, the heat exchange coefficient between the exhaust gases and the lower and upper metal sheets is increased considerably. In the absence of fins, it is of the order of 150 watts/m² Kelvin. In contrast, in the case of the first fluid, this heat exchange coefficient is of the order of 1000 watts/m² Kelvin when the fluid is in the liquid state 10 000 to 15 000 watts/m² Kelvin during the evaporation of the first fluid, and approximately 400 watts/m² Kelvin for the superheated steam at 35 bar (in the case of a water/ethanol mixture 70-30%). The presence of fins enables the heat exchange coefficient of the exhaust gas to approach the heat exchange coefficient of the fluid. Thus, the efficiency of the heat exchanger is much greater, particularly when the latter operates as an evaporator.

Furthermore, the manufacture of this heat exchanger is made easier. In particular, the lower and upper metal sheets are not stamped out. The assembly of the various elements of the heat exchanger is simple, especially because the fins are not brazed to the lower metal sheet 4 or the upper metal sheet 6.

Finally, the heat exchanger is comprised essentially of thin sheets, and is therefore especially lightweight. It has low thermal inertia.

Alternatively, the fins are brazed to the lower and upper metal sheets 4 and 6. To do this, one places by any appropriate means, the strips of filler metal between the tops of the corrugations 76 and the lower metal sheet, and between the bases 80 and the upper metal sheet.

After the pressurizing step 122, one places the heat exchanger in an oven, whereby the first passage is maintained at overpressure with an inert gas (e.g., nitrogen or another inert gas). This gas is at a pressure that is sufficient to press plates 4 and 6 against the fins during the brazing operations. The solder used is nickel based with a melting temperature of about 1100° C.

Although an embodiment of this invention has been disclosed, a worker of ordinary skill in this art would recognize that certain modifications would come within the scope of this disclosure. For that reason, the following claims should be studied to determine the true scope and content of this disclosure.

1. A heat exchanger comprising:
a lower metal sheet;
an upper metal sheet;
a fin sheet defining fins;
the lower metal sheet, the upper metal sheet and the fin sheet being superposed and forming a structure with three layers spirally wound around a central axis and defining a winding, first large faces of the lower metal sheet and of the upper metal sheet facing each other and defining together a first passage for circulation of a first fluid, second large faces of the lower metal sheet and of the upper metal sheet facing each other and defining together a second passage for circulation of a second fluid, in which is positioned the fin sheet; and
a set of spacers, positioned in the first passage, the spacers being rods independent of the lower and upper metal sheets.

2. The heat exchanger according to claim 1, wherein the set of spacers comprises a peripheral spacer, interposed between respective peripheral edges of the lower and upper metal sheets providing a seal between said peripheral edges.

3. The heat exchanger according to claim 2, wherein the peripheral spacer comprises two longitudinal rods extending along long edges of the lower and upper plates.

4. The heat exchanger according to claim 2, wherein the peripheral spacer is a frame having a closed contour.

5. The heat exchanger according to claim 1, wherein the first passage has outer and inner circumferential ends respectively located radially outermost and radially innermost the heat exchanger, the set of spacers comprising at least one central spacer extending circumferentially over most of a length of the first passage and dividing the first passage into an outgoing branch and a returning branch parallel to each other and communicating with each other at the inner circumferential end.

6. The heat exchanger according to claim 5, wherein the heat exchanger comprises a first fluid inlet communicating with the outgoing branch at the outer circumferential end and a first fluid outlet communicating with the returning branch at the outer circumferential end.

7. The heat exchanger according to claim 1, wherein the heat exchanger comprises a cylindrical external casing into which the winding is inserted.

8. The heat exchanger according to claim 7, wherein the lower and upper metal sheets form a determined number of turns around the central axis, the fin sheet forming one extra turn than the lower and upper metal sheets, said extra turn being interposed between the upper metal sheet and the cylindrical external casing.

9. The heat exchanger according to claim 8, wherein the heat exchanger comprises an internal tube around which the structure with three layers is wound, the internal tube being a wound metal sheet with superposition of two axial edges of said wound metal sheet, and/or the external casing being a wound metal sheet with superposition of two axial edges of said wound metal sheet.

10. The heat exchanger according to claim 1, wherein the fin sheet defining the fins is in a folded metal sheet with corrugations, said corrugations forming the fins.

11. The heat exchanger according to claim 1, wherein the fins are corrugations that are parallel to the central axis.

12. The heat exchanger according to claim 1, wherein the fins are blades that extend parallel to the central axis.

13. The heat exchanger according to claim 1, wherein the fins extend across the entire lateral width of the lower and upper metal sheets

14. A method for manufacturing a heat exchanger comprising a lower metal sheet, an upper metal sheet, a fin sheet defining fins, the lower metal sheet, the upper metal sheet and the fin sheet being superposed and forming a structure with three layers spirally wound around a central axis and defining a winding, first large faces of the lower metal sheet and of the upper metal sheet facing each other and defining together a first passage for circulation of a first fluid, second large faces of the lower metal sheet and of the upper metal sheet facing each other and defining together a second passage for circulation of a second fluid, in which is positioned the fin sheet; a set of spacers, positioned in the first passage, the spacers being rods independent of the lower and upper metal sheets, the method including the following steps:
forming the structure with three layers by superposing the lower metal sheet, the upper metal sheet and the fin sheet, with interposition of a set of spacers in the first passage between the lower and upper metal sheets; and
winding the structure with three layers spirally around the central axis.

15. The method according to claim 14, including a step to pressurize the first passage in order to press the upper metal sheet against the fin sheet, carried out after the winding step.

16. The method according to claim 14, including a step to attach a first fluid inlet tube and a first fluid outlet tube onto the upper metal sheet, carried out before the forming step and the winding step.

17. The method according to claim 14, including a step to insert the structure into a cylindrical casing.
